(19) United States
(12) Patent Application Publication
(10) Pub. No.: US 2026/0023623 A1
(43) Pub. Date: Jan. 22, 2026

(54) UPDATE METHOD OF CONTAINER INFRASTRUCTURE CLUSTER, UPDATE SYSTEM OF CONTAINER INFRASTRUCTURE CLUSTER, RENEWAL MANAGEMENT DEVICE, AND UPDATE CONTROL PROGRAM

(71) Applicant: Nippon Telegraph and Telephone Corporation, Tokyo (JP)

(72) Inventors: Kenta Shinohara, Musashino-shi, Tokyo (JP); Yuki AKAMATSU, Musashino-shi, Tokyo (JP); Fumihiko SAWAZAKI, Musashino-shi, Tokyo (JP); Susumu NAKAZAWA, Musashino-shi, Tokyo (JP)

(21) Appl. No.: 18/875,486

(22) PCT Filed: Jun. 20, 2022
(86) PCT No.: PCT/JP2022/024501

§ 371 Date: Dec. 16, 2024

(51) Int. Cl. G06F 9/50

(52) U.S. Cl. CPC G06F 9/5077; G06F 9/5083; G06F 2209/505

(57) ABSTRACT

An update management device (300) controls update of a container platform cluster (100) belonging to a first container platform identifier (cluster1). The update management device (300) includes a container platform construction unit (310) that constructs a second container platform cluster (400) belonging to a second container platform identifier (cluster2), an application construction unit (320), a communication control policy switching instruction unit (330) that sets a communication control policy, and a communication destination container platform change instruction unit (340) that changes the first container platform identifier (cluster1) to the second container platform identifier (cluster2).

### TECHNICAL FIELD

The present invention relates to a container platform cluster update method, an update system for a container platform cluster, an update management device, and an update control program in an update system for a container platform cluster using a virtualization technology.

### BACKGROUND ART

In recent years, Kubernetes has become widespread as orchestration software for integrated management of container platform clusters (Non Patent Literature 1). Additionally, in connection with this, a blue-green method has been disclosed as a method for updating an application and a container platform (Non Patent Literature 2).

### CITATION LIST

### Non Patent Literature

Non Patent Literature 1: “Production grade no container kanri kiban (in Japanese) (Production-grade container management platform)”, [online], kubernetes, Jun. 5, 2020, [retrieved on Jun. 3, 2022], Internet <https://kubernetes.io/ja/>
Non Patent Literature 2: “What is blue green deployment?”, Jan. 8, 2019, [online], Red Hat, [Retrieved on Jun. 3, 2022], Internet <https://www.redhat.com/ja/topics/devops/what-is-blue-green-deployment>

### SUMMARY OF INVENTION

### Technical Problem

With a blue-green update, a plurality of applications may start at the same time, and in applications that periodically execute processing, problems may occur due to other processing being executed at the same time.

Here, an example of an application that periodically executes processing is an application that periodically collects database values (for example, every hour), aggregates the collected results, and outputs statistical information. In such an application, simultaneous execution of a plurality of programs may result in inconsistent collection intervals and inaccurate statistical information.

The present invention has been made in view of such a point, and an object of the present invention is to update a container platform on which a periodic execution application that periodically executes processing and a standby application of a standby type operate in a mixed manner with a blue-green update without causing any problems.

### Solution to Problem

A container platform cluster update method according to the present invention is a method for updating a first container platform cluster on which a first container platform and a first application management device are constructed, the first container platform cluster belonging to a first container platform identifier, a standby application and a periodic execution application being constructed on the first container platform, the method including: a step in which an update management device constructs a second container platform of a second container platform cluster belonging to a second container platform identifier, and a second application management device; a step in which the update management device causes the second container platform to construct a standby application and a periodic execution application; a step in which the update management device sets, in a load balancer, communication control policies for the standby application and the periodic execution application constructed on the second container platform; and a step in which the update management device changes the first container platform identifier of the load balancer to the second container platform identifier.

### Advantageous Effects of Invention

According to the present invention, it is possible to update a container platform on which a periodic execution application that periodically executes processing and a standby application of a standby type operate in a mixed manner with a blue-green update without causing any problems.

### BRIEF DESCRIPTION OF DRAWINGS

FIG. 1 is a block diagram illustrating an overall configuration of an update system for a container platform cluster according to an embodiment.

FIG. 2 is an explanatory diagram illustrating an initial state of the update system for a container platform cluster.

FIG. 3 is a flowchart illustrating a flow of update control processing executed by an update management device of the update system for a container platform cluster.

FIG. 4 is an explanatory diagram illustrating that a container platform construction unit constructs a container platform cluster whose container platform identifier is “cluster2”, and a container platform, a container platform management device, and an application management device are constructed.

FIG. 5 is an explanatory diagram illustrating that an application construction unit constructs a standby application and a periodic execution application on a container platform through an application management device.

FIG. 6 is an explanatory diagram illustrating that a communication control policy switching instruction unit instructs an application management device to set “SG3” as a communication control policy of a standby application and “SG3” and “SG4” are added to a communication control policy of a load balancer.

FIG. 7 is an explanatory diagram illustrating a state in which the update management device switches a communication path from a container platform cluster to a new container platform cluster.

FIG. 8 is an explanatory diagram illustrating that the container platform construction unit deletes a container platform, a container platform management device, and an application management device whose container platform identifier is “cluster1”.

FIG. 9 is a hardware configuration diagram illustrating an example of a computer that implements functions of the update management device.

### DESCRIPTION OF EMBODIMENTS

Next, a mode for carrying out the present invention (hereinafter referred to as the “present embodiment”) will be described.

### <Update System for Container Platform Cluster>

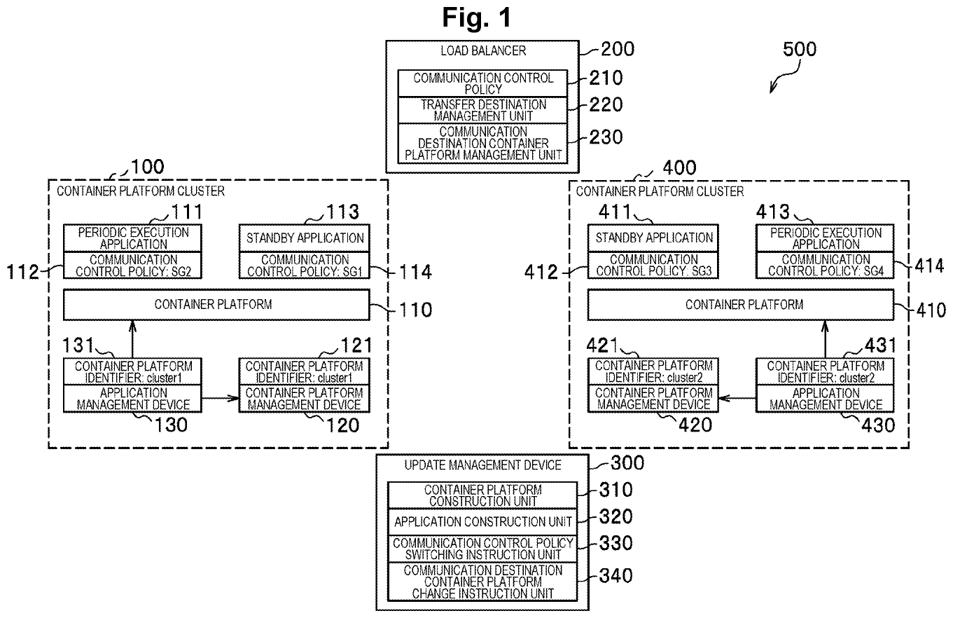

FIG. 1 is a block diagram illustrating an overall configuration of an update system for a container platform cluster according to the present embodiment. Note that FIG. 1 illustrates a basic configuration during operation at the time of update.

As illustrated in FIG. 1, an update system 500 for a container platform cluster 100 includes: a container platform cluster 100 (first container platform cluster) on which a container platform 110 (first container platform), a container platform management device 120 (first container platform management device), and an application management device 130 (first application management device) are constructed, the container platform cluster 100 belonging to cluster1 (first container platform identifier), a standby application 113 and a periodic execution application 111 being constructed on the container platform 110; an update management device 300 that controls update of the container platform cluster 100; and a load balancer 200 that transfers an application to the container platform cluster 100. Different communication control policies are set for the standby application 113 and the periodic execution application 111.

In addition, the update system 500 for the container platform cluster 100 includes a container platform cluster 400. The container platform cluster 400 (second container platform cluster) includes a container platform 410 (second container platform), a container platform management device 420 (second container platform management device), and an application management device 430 (second application management device), and belongs to cluster2 (second container platform identifier).

The container platform cluster 100 is a container platform cluster that is currently operated, and corresponds to a so-called blue system (old system). On the other hand, the container platform cluster 400 is a container platform cluster that is scheduled to be updated and operated, and corresponds to a so-called green system (new system).

### [Container Platform Cluster (Blue System)]

The container platform cluster 100 includes a container platform 110, a container platform management device 120, and an application management device 130.

The container platform 110 is a container platform typified by kubernetes, and is a system including a group of server devices on which applications are installed. The container platform cluster 100 always belongs to one container platform identifier. The container platform 110 is assigned cluster1 as a container platform identifier.

The standby application 113 is a container type application that operates on the container platform 110, and is an application that waits for communication from the outside and executes processing in response to received requests. The standby application 113 has a communication control policy control function and can communicate only with an authorized resource (load balancer 200). The standby application 113 is assigned SG1 as a communication control policy 114.

The periodic execution application 111 is a container type application that operates on the container platform 110, and is an application that periodically executes some processing and communicates with the outside of the container platform cluster 100 as necessary. The periodic execution application 111 has a communication control policy control function and can communicate only with an authorized resource (load balancer 200). The periodic execution application 111 is assigned SG2 as a communication control policy 112.

The container platform management device 120 is a device that manages the configuration and operation of the container platform cluster 100. The container platform management device 120 always belongs to one container platform identifier. The container platform management device 120 is assigned cluster1 as a container platform identifier 121.

The application management device 130 is a device that manages an application operating on the container platform 110 with respect to the container platform 110 having a container platform identifier set therein. The application management device 130 belongs to one or more container platform identifiers. In the present embodiment, the application management device 130 is assigned cluster1 as a container platform identifier 131. In the present embodiment, as an example, one application management device is assigned to one container platform identifier, but for example, by making the application management device 130 also belong to cluster2, the application management device 130 can be shared with the application management device 430.

### [Load Balancer]

The load balancer 200 is a device that receives communication from outside the system and transfers an application onto the container platform 110. The load balancer 200 includes a communication control policy 210, a transfer destination management unit 220, and a communication destination container platform management unit 230.

The communication control policy 210 is a communication control policy control function, and the load balancer 200 can communicate only with authorized resources (standby application 113, periodic execution application 111).

The transfer destination management unit 220 manages address information (the Internet Protocol (IP) address and communication port number of connection destination) of a transfer destination to an application on the container platform 110.

The communication destination container platform management unit 230 manages container platform identifier information (cluster1), connects to the container platform management device having the set container platform identifier, and acquires address information (IP address and communication port number) of the container platform.

### [Update Management Device]

The update management device 300 is a device that manages updates of the container platform 110, the periodic execution application 111, and the standby application 113. The update management device 300 includes a container platform construction unit 310, an application construction unit 320, a communication control policy switching instruction unit 330, and a communication destination container platform change instruction unit 340.

The container platform construction unit 310 has a function of constructing the container platform 410, the container platform management device 420, and the application management device 430. The container platform construction unit 310 also has a function of deleting the container platform 110, the container platform management device 120, and the application management device 130 in the container platform cluster 100 of cluster1.

The application construction unit 320 has a function of instructing the application management device 430 to construct the standby application 411 and the periodic execution application 413. In addition, the application construction unit 320 can control a timing at which the application management device 130 deletes the communication control policy of the periodic execution application 111 constructed on the container platform 110.

The communication control policy switching instruction unit 330 has a function of setting and changing the communication control policy to the load balancer 200 and the application management devices 130 and 430. For example, the communication control policy switching instruction unit 330 sets “SG1” and “SG2” in the communication control policy to the load balancer 200. Further, for example, the communication control policy switching instruction unit 330 sets “SG1” in the communication control policy 114 of the standby application 113 and sets “SG2” in the communication control policy 112 of the periodic execution application 111.

In addition, the communication control policy switching instruction unit 330 causes the application management device 430 and the load balancer 200 to set different communication control policies for the standby application 411 and the periodic execution application 413 of cluster2, and causes the application management device 130 and the load balancer 200 to delete the communication control policies of the standby application 113 and the periodic execution application 111 of cluster1.

The communication destination container platform change instruction unit 340 has a function of instructing the load balancer 200 to change the communication destination container platform. For example, the communication destination container platform change instruction unit 340 can change the container platform identifier from “cluster1” to “cluster2”, and can also change the container platform identifier from “cluster2” to “cluster1”.

### [Container Platform Cluster (Green System)]

The container platform cluster 400 includes a container platform 410, a container platform management device 420, and an application management device 430.

The container platform 410 is a container platform typified by kubernetes, and is a system including a group of server devices on which applications are installed. The container platform cluster 400 always belongs to one container platform identifier. The container platform 410 is assigned cluster2 as a container platform identifier. In the container platform 410, a standby application 411 and a periodic execution application 413 are constructed.

The standby application 411 is a container type application that operates on the container platform 410, and is an application that waits for communication from the outside and executes processing in response to received requests. The standby application 411 has a communication control policy control function and can communicate only with an authorized resource (load balancer 200). The standby application 411 is assigned SG3 as a communication control policy 412.

The periodic execution application 413 is a container type application that operates on the container platform 410, and is an application that periodically executes some processing and communicates with the outside of the container platform cluster 400 as necessary. The periodic execution application 413 has a communication control policy control function and can communicate only with an authorized resource (load balancer 200). The periodic execution application 413 is assigned SG4 as a communication control policy 414.

The container platform management device 420 is a device that manages the configuration and operation of the container platform cluster 400. The container platform management device 420 always belongs to one container platform identifier. The container platform management device 420 is assigned cluster2 as a container platform identifier 421.

The application management device 430 is a device that manages an application operating on the container platform 410 with respect to the container platform 410 having a container platform identifier set therein. The application management device 430 belongs to one or more container platform identifiers. In the present embodiment, the application management device 430 is assigned cluster2 as a container platform identifier 431. In the present embodiment, as an example, one application management device is assigned to one container platform identifier, but for example, by making the application management device 430 also belong to cluster1, the application management device 430 can be shared with the application management device 130.

### <Initial State>

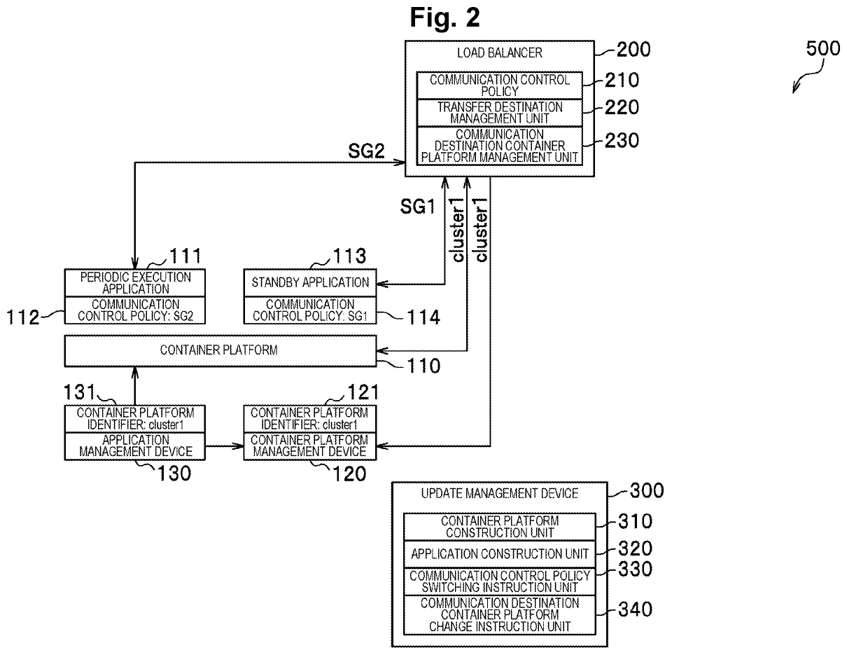

FIG. 2 is an explanatory diagram illustrating an initial state of the update system for the container platform cluster.

In the update system 500 for the container platform cluster 100, the container platform identifier is set to “cluster1”, and the container platform 110, the container platform management device 120, and the application management device 130 whose container platform identifier is “cluster1” are operating. The communication control policies of the standby application 113 and the load balancer 200 have been assigned “SG1” and they are in a communicable state.

The communication control policies of the periodic execution application 111 and the load balancer 200 have been assigned “SG2” and they are in a communicable state. In the communication destination container platform management unit 230 of the load balancer 200, “cluster1” is set as the container platform identifier, address information (IP address and communication port number) for an application on the container platform 110 is periodically acquired, and the transfer destination management unit 220 manages the address information.

### <Update Control Processing>

The update management device 300 of the update system 500 for the container platform cluster 100 according to the present embodiment updates the container platform cluster 100 to the container platform cluster 400.

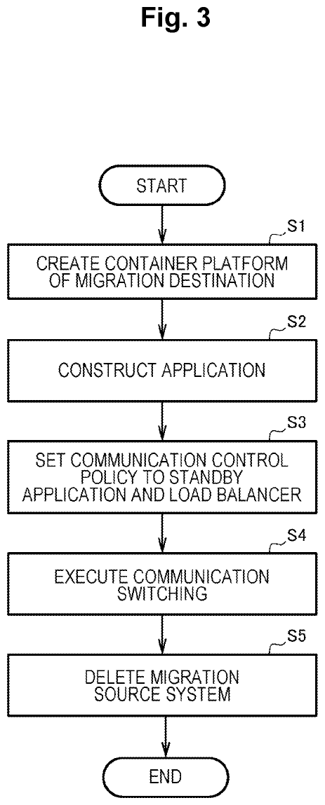

FIG. 3 is a flowchart illustrating a flow of update control processing executed by the update management device of the update system for the container platform cluster.

First, the update management device 300 creates a container platform of a migration destination (step S1). In this case, the container platform construction unit 310 of the update management device 300 constructs the container platform 410, the container platform management device 420, and the application management device 430 whose container platform identifier is “cluster2”.

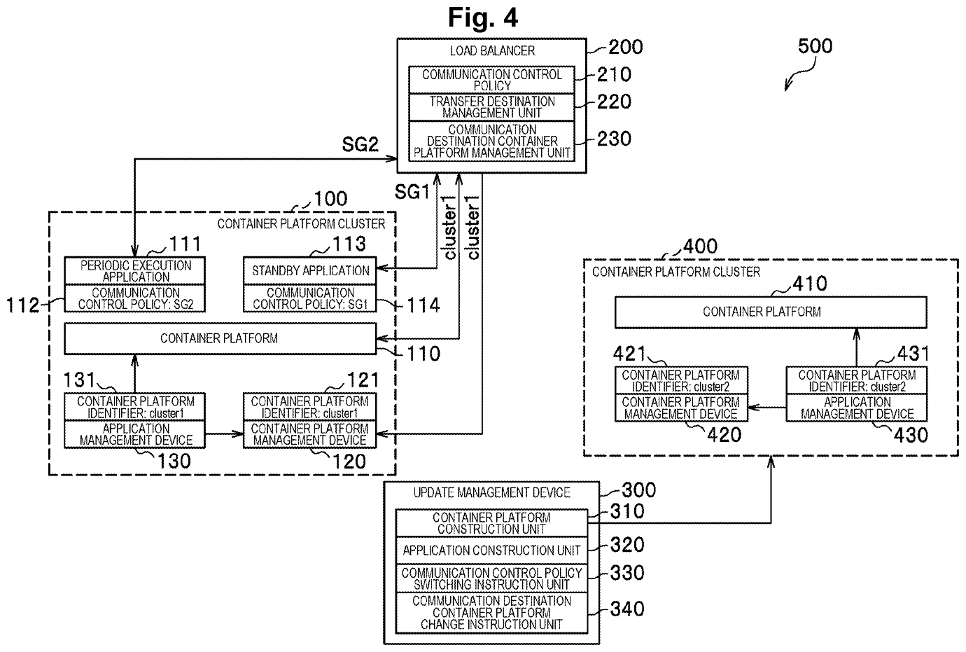

FIG. 4 is an explanatory diagram illustrating that a container platform construction unit constructs a container platform cluster whose container platform identifier is “cluster2”, and a container platform, a container platform management device, and an application management device are constructed.

As illustrated in FIG. 4, in the update system 500 for the container platform cluster 100, the container platform 410, the container platform management device 420, and the application management device 430 whose container platform identifier is “cluster2” are constructed. In this way, the container platform construction unit 310 of the update management device 300 creates the container platform cluster 400 whose container platform identifier is “cluster2”.

Description will continue by referring back to FIG. 3.

Next, the update management device 300 instructs the application management device 430 to construct an application (step S2). In this case, the application construction unit 320 of the update management device 300 instructs the application management device 430 to construct the standby application 411 and the periodic execution application 413.

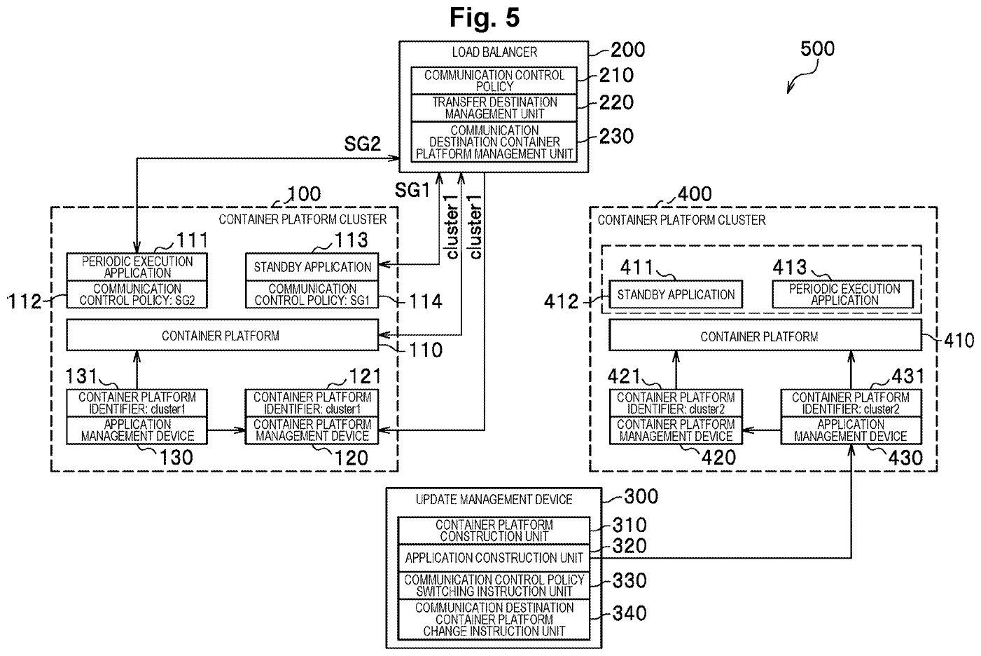

FIG. 5 is an explanatory diagram illustrating that the application construction unit constructs the standby application and the periodic execution application on the container platform through the application management device.

As illustrated in FIG. 5, in the container platform cluster 400, the standby application 411 and the periodic execution application 413 are constructed on the container platform 410. Note that the standby application 411 and the periodic execution application 413 are in an operable state, but cannot communicate with the load balancer 200 because the communication control policy has not been set yet.

Description will continue by referring back to FIG. 3.

Next, the update management device 300 sets a communication control policy to the standby application 411 and the load balancer 200 (step S3). In this case, the communication control policy switching instruction unit 330 of the update management device 300 instructs the application management device 430 to set “SG3” as the communication control policy of the standby application 411.

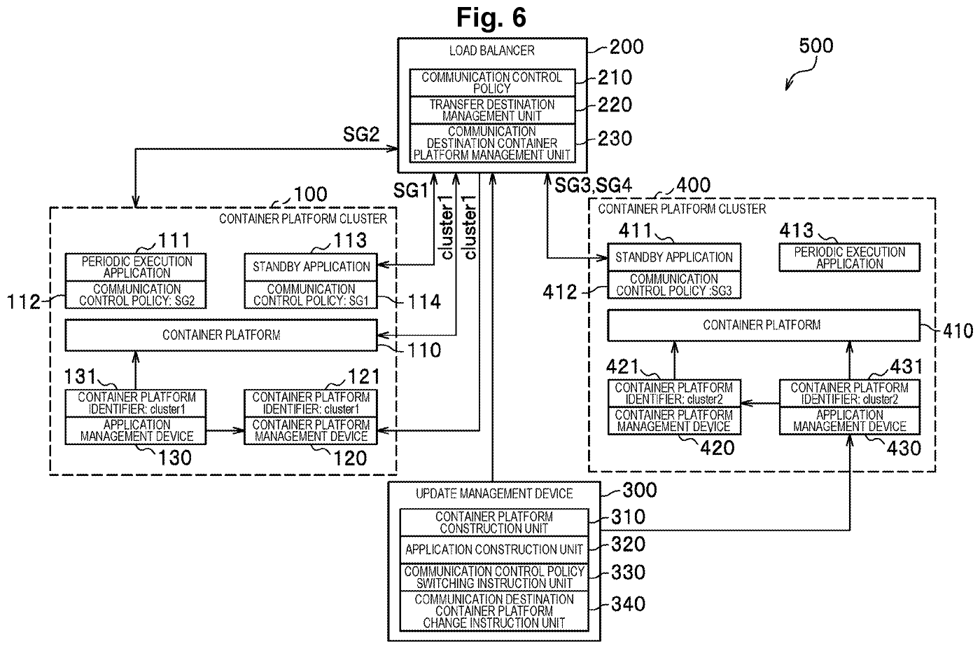

FIG. 6 is an explanatory diagram illustrating that the communication control policy switching instruction unit instructs the application management device to set “SG3” as the communication control policy of the standby application and “SG3” and “SG4” are added to the communication control policy of the load balancer.

As illustrated in FIG. 6, the application management device 430 sets “SG3” as the communication control policy of the standby application 411 on the container platform 410 through the container platform management device 420.

Furthermore, the communication control policy switching instruction unit 330 of the update management device 300 adds “SG3” and “SG4” to the communication control policy 210 of the load balancer 200.

In this way, “SG3” is set as the communication control policy in the standby application 411 of the container platform cluster 400. Additionally, “SG3” and “SG4” are added to the communication control policy of the load balancer 200.

Therefore, in the update system 500 for the container platform cluster 100, the standby application 411 and the load balancer 200 are changed to a state in which communication is permitted.

Description will continue by referring back to FIG. 3.

Next, the update management device 300 executes communication switching (step S4). In this case, the update management device 300 issues an instruction to delete the communication control policy of the container platform cluster 100 and an instruction to set the communication control policy of the container platform cluster 400.

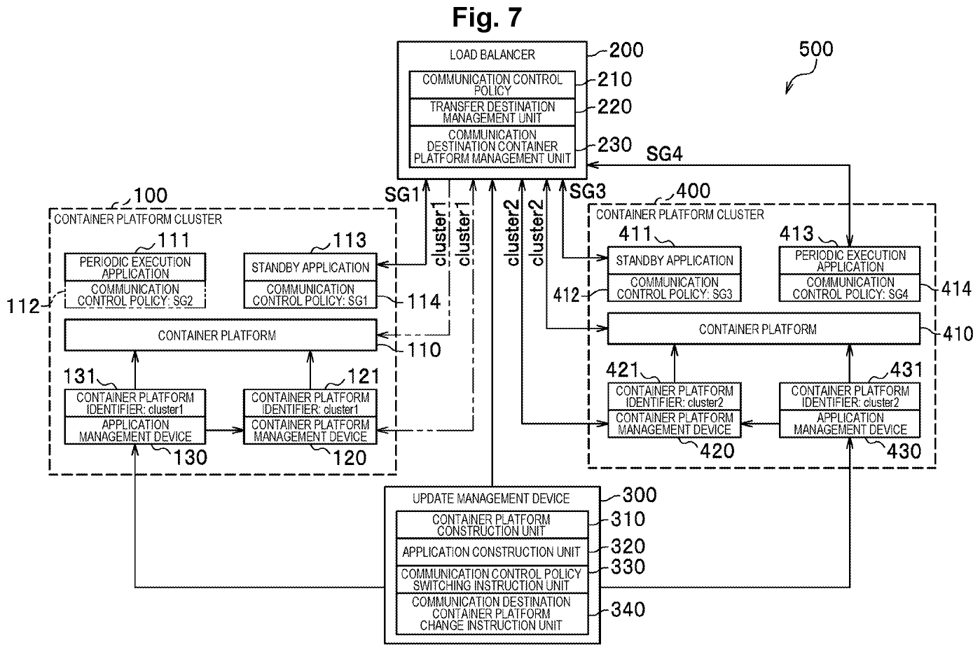

FIG. 7 is an explanatory diagram illustrating a state in which the update management device switches a communication path from a container platform cluster to a container platform cluster.

As illustrated in FIG. 7, the communication control policy switching instruction unit 330 of the update management device 300 instructs the application management device 130 to delete “SG2” which is the communication control policy 112 of the periodic execution application 111. The application management device 130 deletes “SG2” which is the communication control policy 112 of the periodic execution application 111 on the container platform 110 through the container platform management device 120. Furthermore, the communication control policy switching instruction unit 330 of the update management device 300 deletes “SG2” from the communication control policy 210 of the load balancer 200. Accordingly, the periodic execution application 111 cannot communicate with the load balancer 200 and cannot execute processing.

In addition, the communication control policy switching instruction unit 330 instructs the application management device 430 to set “SG4” as the communication control policy 414 of the periodic execution application 413. In this case, the application management device 430 sets “SG4” to the communication control policy 414 of the periodic execution application 413 on the container platform 410 through the container platform management device 420.

The communication destination container platform change instruction unit 340 of the update management device 300 instructs the communication destination container platform management unit 230 of the load balancer 200 to change the container platform identifier from “cluster1” to “cluster2”. The communication destination container platform management unit 230 of the load balancer 200 connects to the container platform management device 420 whose container platform identifier is “cluster2”, acquires the address information (IP address and communication port number) of the container platform 410, and changes the transfer destination address information of the transfer destination management unit 220.

Accordingly, the update system 500 for the container platform cluster 100 is in a state in which the communication path from the load balancer 200 is changed from the container platform cluster 100 to the container platform cluster 400.

Description will continue by referring back to FIG. 3.

Next, the update management device 300 deletes a migration source system (step S5). In this case, the container platform construction unit 310 of the update management device 300 issues an instruction to delete the container platform cluster 100, which is the migration source system that is no longer needed.

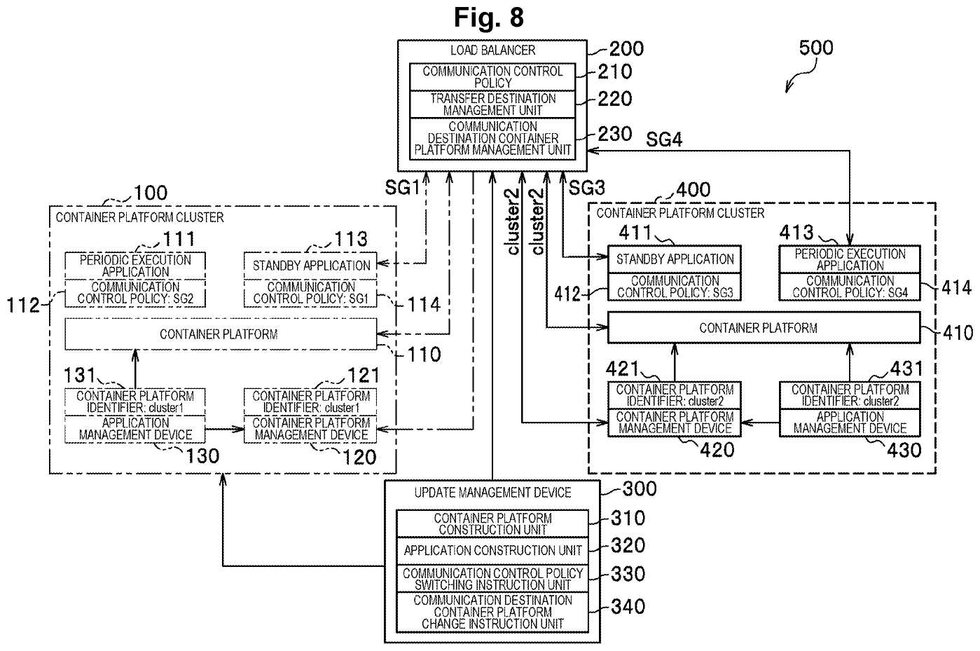

FIG. 8 is an explanatory diagram illustrating that the container platform construction unit deletes a container platform, a container platform management device, and an application management device whose container platform identifier is “cluster1”.

As illustrated in FIG. 8, the container platform construction unit 310 of the update management device 300 deletes the container platform cluster 100 which is the migration source system. In this case, the container platform construction unit 310 of the update management device 300 deletes the container platform 110, the container platform management device 120, and the application management device 130 whose container platform identifier is “cluster1”.

Furthermore, the communication control policy switching instruction unit 330 of the update management device 300 deletes “SG1” from the communication control policy 210 of the load balancer 200. In this way, when the container platform construction unit 310 of the update management device 300 deletes the container platform cluster 100 and the communication control policy switching instruction unit 330 of the update management device 300 deletes “SG1” from the communication control policy 210 of the load balancer 200, the processing ends.

Further, in the update system 500 for a container platform cluster according to the present embodiment, in step S4 of the flowchart of FIG. 3, the update management device 300 may control a timing at which the application management device 130 deletes “SG2” of the communication control policy 112 of the periodic execution application 111 constructed on the container platform 110.

For example, the communication control policy switching instruction unit 330 of the update management device 300 may control a timing at which an instruction to delete “SG2” of the communication control policy 112 of the periodic execution application 111 is executed by the application management device 130. Accordingly, the update system 500 for the container platform cluster 100 can avoid deleting “SG2” of the communication control policy 112 while the periodic execution application 111 is executing processing.

For example, in a case where the periodic execution application 111 executes at a fixed time (for example, at 0 minutes of every hour) in one day, the deletion of “SG2” of the communication control policy 112 is executed while avoiding the execution time. Alternatively, by acquiring the execution time of the next periodic execution application 111 via the application management device 130, the application management device 130 may execute the deletion instruction while avoiding the execution time.

### <Hardware Configuration of Update Management Device>

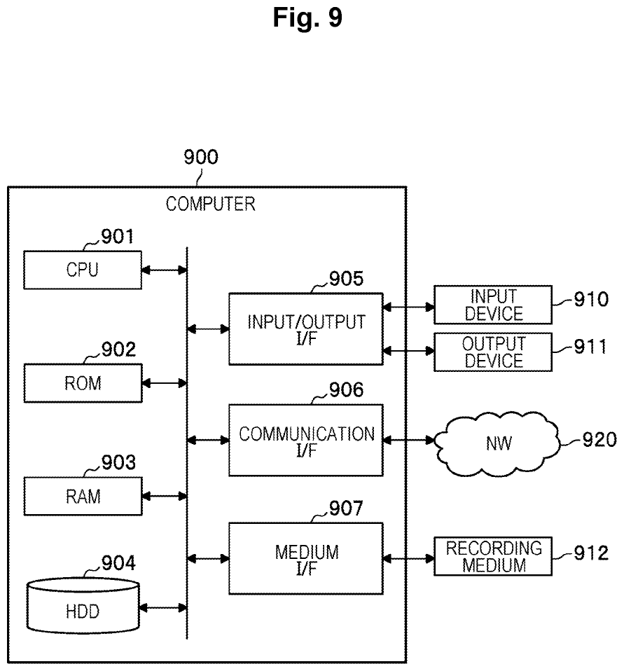

The update management device 300 according to the present embodiment is implemented by, for example, a computer 900 having a configuration as illustrated in FIG. 9.

FIG. 9 is a hardware configuration diagram illustrating an example of a computer that implements functions of the update management device. The computer 900 includes a central processing unit (CPU) 901, a read only memory (ROM) 902, a random access memory (RAM) 903, a hard disk drive (HDD) 904, an input/output interface (I/F) 905, a communication I/F 906, and a medium I/F 907.

The CPU 901 operates on the basis of a program (update control program) stored in the ROM 902 or the HDD 904 to embody the container platform construction unit 310, the application construction unit 320, the communication control policy switching instruction unit 330, and the communication destination container platform change instruction unit 340. The ROM 902 stores a boot program to be executed by the CPU 901 when the computer 900 is started, a program related to hardware of the computer 900, and the like.

The CPU 901 controls, via the input/output I/F 905, an input device 910 such as a mouse or a keyboard, and an output device 911 such as a display or a printer. Via the input/output I/F 905, the CPU 901 acquires data from the input device 910, and outputs generated data to the output device 911. Note that a graphics processing unit (GPU) or the like may be used as a processor in conjunction with the CPU 901.

The HDD 904 stores a program to be executed by the CPU 901, data to be used by the program, and the like. The communication I/F 906 receives data from another device via a communication network (for example, a network (NW) 920), outputs the data to the CPU 901, and transmits data generated by the CPU 901 to another device via the communication network.

The medium I/F 907 reads a program (update control program) or data stored in a recording medium 912, and outputs the read program or data to the CPU 901 via the RAM 903. The CPU 901 loads a program related to target processing from the recording medium 912 into the RAM 903 via the medium I/F 907, and executes the loaded program. The recording medium 912 is an optical recording medium such as a digital versatile disc (DVD) or a phase change rewritable disk (PD), a magneto-optical recording medium such as a magneto-optical disk (MO), a magnetic recording medium, a semiconductor memory, or the like.

For example, in a case where the computer 900 functions as the update management device 300 of the present invention, the CPU 901 of the computer 900 implements each function of the update management device 300 by executing the program loaded on the RAM 903. In addition, the HDD 904 stores data in the RAM 903. The CPU 901 reads a program related to target processing from the recording medium 912, and executes the program. Additionally, the CPU 901 may read a program related to target processing from another device via the communication network (NW 920).

### <Effects>

Hereinafter, effects of the update control method of the update system 500 for the container platform cluster according to the present invention will be described.

The container platform cluster update method according to the present invention is a method for updating the container platform cluster 100 (first container platform cluster) on which the container platform 110 (first container platform) and the application management device 130 (first application management device) are constructed, the container platform cluster 100 belonging to cluster1 (first container platform identifier), the standby application 113 and the periodic execution application 111 being constructed on the container platform 110, the method including: a step in which the update management device 300 constructs the container platform 410 (second container platform) of the container platform cluster 400 (second container platform cluster) belonging to cluster2 (second container platform identifier), and the application management device 430 (second application management device); a step in which the update management device 300 causes the container platform 410 to construct the standby application 411 and the periodic execution application 413; a step in which the update management device 300 sets, in the load balancer 200, different communication control policies for the standby application 411 and the periodic execution application 413 constructed on the container platform 410; and a step in which the update management device 300 changes cluster1 of the load balancer 200 to cluster2.

With the container platform cluster update method according to the present invention, different communication control policies are set for the standby application 411 and the periodic execution application 413 constructed on the container platform 410 in the load balancer 200. Accordingly, since the communication control policy of the standby application 411 and the communication control policy of the periodic execution application 413 can be switched, it is possible to update the container platform 110 on which the periodic execution application 413 and the standby application 411 operate in a mixed manner with a blue-green update without causing any problems.

In addition, the container platform cluster update method according to the present invention further includes: a step in which the update management device 300 causes the application management device 130 to delete a communication control policy of the periodic execution application 111 constructed on the container platform 110; a step in which the update management device 300 deletes, from the load balancer 200, a communication control policy of the periodic execution application 111 constructed on the container platform 110; a step in which the update management device 300 deletes the container platform 110 and the application management device 130 of the container platform cluster 100 belonging to cluster1; and a step in which the update management device 300 deletes, from the load balancer 200, a communication control policy of the standby application 113 constructed on the container platform 110.

In this way, according to the container platform cluster update method, since the communication control policy 112 of the periodic execution application 111 can be deleted and the container platform 110, the container platform management device 120, and the application management device 130 can be deleted, it is possible to effectively utilize the virtualization resources.

In addition, the container platform cluster update method according to the present invention further includes a step in which the update management device 300 controls a timing at which the application management device 130 deletes the periodic execution application 111 constructed on the container platform 110.

In this way, with the container platform cluster update method according to the present invention, it is possible to control the timing at which the application management device 130 deletes the periodic execution application 111, and thus it is possible to prevent the communication control policy 112 from being deleted during the execution of the periodic execution application 111.

In addition, the update system 500 for the container platform cluster 100 according to the present invention is an update system for a container platform cluster, the update system including: the container platform cluster 100 on which the container platform 110, the container platform management device 120, and the application management device 130 are constructed, the container platform cluster 100 belonging to cluster1, the standby application 113 and the periodic execution application 111 being constructed on the container platform 110; the update management device 300 that controls update of the container platform cluster 100; and the load balancer 200 that transfers an application to the container platform cluster 100, in which different communication control policies are set for the standby application 113 and the periodic execution application 111, and the update management device 300 includes: the container platform construction unit 310 that includes the container platform 410, the container platform management device 420, and the application management device 430, and that constructs the container platform cluster 400 belonging to a container platform identifier of cluster2; the application construction unit 320 that constructs the standby application 411 and the periodic execution application 413 on the container platform 410; the communication control policy switching instruction unit 330 that causes the application management device 430 and the load balancer 200 to set different communication control policies for the standby application 411 and the periodic execution application 413 of cluster2; and the communication destination container platform change instruction unit 340 that changes cluster1 set in the load balancer 200 to cluster2.

With the update system 500 for the container platform cluster 100 according to the present invention, different communication control policies are set for the standby application 411 and the periodic execution application 413 constructed on the container platform 410 in the load balancer 200. Accordingly, since the communication control policy of the standby application 411 and the communication control policy of the periodic execution application 413 can be switched, it is possible to update the container platform 110 on which the periodic execution application 413 and the standby application 411 operate in a mixed manner with a blue-green update without causing any problems.

In addition, in the update system 500 for the container platform cluster 100 according to the present invention, the container platform construction unit 310 deletes the container platform 110, the container platform management device 120, and the application management device 130 in the container platform cluster 100 of cluster1, and the communication control policy switching instruction unit 330 causes the application management device 130 to delete a communication control policy of the periodic execution application 111 of cluster1, and deletes, from the load balancer 200, communication control policies of the periodic execution application and the standby application of cluster1.

In this way, with the update system 500 for the container platform cluster 100 according to the present invention, since the container platform 110, the container platform management device 120, and the application management device 130 can be deleted, and the communication control policies of the periodic execution application and the standby application of cluster1 can be deleted, it is possible to effectively use the virtualization resources.

Further, the update management device 300 according to the present invention is the update management device 300 that controls update of the container platform cluster 100 on which the container platform 110, the container platform management device 120, and the application management device 130 are constructed, the container platform cluster 100 belonging to cluster1, the standby application 113 and the periodic execution application 111 being constructed on the container platform 110, the update management device 300 including: the container platform construction unit 310 that includes the container platform 410, the container platform management device 420, and the application management device 430, and that constructs the container platform cluster 400 belonging to cluster2; the application construction unit 320 that constructs the standby application 411 and the periodic execution application 413 on the container platform 410; the communication control policy switching instruction unit 330 that causes the application management device 430 and the load balancer 200 to set different communication control policies for the standby application 411 and the periodic execution application 413 of cluster2; and the communication destination container platform change instruction unit 340 that changes cluster1 set in the load balancer 200 to cluster2.

In this way, with the update management device 300 according to the present invention, different communication control policies are set for the standby application 411 and the periodic execution application 413 constructed on the container platform 410 in the load balancer 200. Accordingly, since the communication control policy of the standby application 411 and the communication control policy of the periodic execution application 413 can be switched, it is possible to update the container platform 110 on which the periodic execution application 413 and the standby application 411 operate in a mixed manner with a blue-green update without causing any problems.

In addition, in the update management device 300 according to the present invention, the container platform construction unit 310 deletes the container platform 110, the container platform management device 120, and the application management device 130 in the container platform cluster 100 of cluster1, and the communication control policy switching instruction unit 330 causes the application management device 130 to delete a communication control policy of the periodic execution application 111 of cluster1, and deletes, from the load balancer 200, communication control policies of the periodic execution application and the standby application of cluster1.

In this way, with the update management device 300 according to the present invention, since the container platform 110, the container platform management device 120, and the application management device 130 can be deleted, and the communication control policies of the periodic execution application and the standby application of cluster1 can be deleted, it is possible to effectively use the virtualization resources.

Note that the present invention is not limited to the above-described embodiment, and many modifications can be made by those skilled in the art within the technical idea of the present invention.

### REFERENCE SIGNS LIST

100 Container platform cluster (first container platform cluster)
110 Container platform (first container platform)
111 Periodic execution application
112 Communication control policy
113 Standby application
114 Communication control policy
120 Container platform management device (first container platform management device)
121 Container platform identifier (first container platform identifier)
130 Application management device (first application management device)
131 Container platform identifier (first container platform identifier)
200 Load balancer
210 Communication control policy
220 Transfer destination management unit
230 Communication destination container platform management unit
300 Update management device
310 Container platform construction unit
320 Application construction unit
330 Communication control policy switching instruction unit
340 Communication destination container platform change instruction unit
400 Container platform cluster (second container platform cluster)
410 Container platform (second container platform)
411 Standby application
412 Communication control policy
413 Periodic execution application
414 Communication control policy
420 Container platform management device (second container platform management device)
421 Container platform identifier (second container platform identifier)
430 Application management device (second application management device)
431 Container platform identifier (second container platform identifier)
500 Update system

1. A container platform cluster update method for updating a first container platform cluster on which a first container platform and a first application management device are constructed, the first container platform cluster belonging to a first container platform identifier, a standby application and a periodic execution application being constructed on the first container platform, the method comprising:
constructing, by an update management device, a second container platform of a second container platform cluster belonging to a second container platform identifier, and a second application management device;
causing, by the update management device, the second container platform to construct a standby application and a periodic execution application;
setting, by the update management device, in a load balancer, different communication control policies for the standby application and the periodic execution application constructed on the second container platform; and
changing, by the update management device, the first container platform identifier of the load balancer to the second container platform identifier.

2. The container platform cluster update method according to claim 1, further comprising:
causing, by the update management device, the first application management device to delete a communication control policy of the periodic execution application constructed on the first container platform;
detecting, the update management device, from the load balancer, a communication control policy of the periodic execution application constructed on the first container platform;
deleting, by the update management device, the first container platform and the first application management device of the container platform cluster belonging to the first container platform identifier; and
deleting, the update management device, from the load balancer, a communication control policy of the standby application constructed on the first container platform.

3. The container platform cluster update method according to claim 2, further comprising:
controlling, by the update management device, a timing at which the first application management device deletes the communication control policy of the periodic execution application constructed on the first container platform.

4. An update system for a container platform cluster, the update system comprising:
a first container platform cluster on which a first container platform, a first container platform management device, and a first application management device are constructed, the first container platform cluster belonging to a first container platform identifier, a standby application and a periodic execution application being constructed on the first container platform;
an update management device, including one or more processors, configured to control update of the first container platform cluster; and
a load balancer, including one or more processors, configured to transfer an application to the first container platform cluster, wherein
different communication control policies are set for the standby application and the periodic execution application, and
the update management device includes:
a container platform construction unit that includes a second container platform, a second container platform management device, and a second application management device, and is configured to construct a second container platform cluster belonging to a second container platform identifier;
an application construction unit configured to construct a standby application and a periodic execution application on the second container platform;
a communication control policy switching instruction unit configured to cause the second application management device and the load balancer to set different communication control policies for the standby application and the periodic execution application of the second container platform identifier; and
a communication destination container platform change instruction unit configured to change the first container platform identifier set in the load balancer to the second container platform identifier.

5. The update system for a container platform cluster according to claim 4, wherein
the container platform construction unit is configured to delete the first container platform, the first container platform management device, and the first application management device in the container platform cluster of the first container platform identifier, and
the communication control policy switching instruction unit is configured to cause the first application management device to delete a communication control policy of the periodic execution application of the first container platform identifier, and delete, from the load balancer, communication control policies of the periodic execution application and the standby application of the first container platform identifier.

6. An update management device that controls update of a first container platform cluster on which a first container platform, a first container platform management device, and a first application management device are constructed, the first container platform cluster belonging to a first container platform identifier, a standby application and a periodic execution application being constructed on the first container platform, the update management device comprising:
a container platform construction unit that includes a second container platform, a second container platform management device, and a second application management device, and is configured to construct a second container platform cluster belonging to a second container platform identifier;
an application construction unit, including one or more processors, configured to construct a standby application and a periodic execution application on the second container platform;
a communication control policy switching instruction unit, including one or more processors, configured to cause the second application management device and a load balancer to set different communication control policies for the standby application and the periodic execution application of the second container platform identifier; and
a communication destination container platform change instruction unit, including one or more processors, configured to change the first container platform identifier set in the load balancer to the second container platform identifier.

7. The update management device according to claim 6, wherein
the container platform construction unit is configured to delete the first container platform, the first container platform management device, and the first application management device in the container platform cluster of the first container platform identifier, and
the communication control policy switching instruction unit is configured to cause the first application management device to delete a communication control policy of a periodic execution application of the first container platform identifier, and delete, from the load balancer, communication control policies of the periodic execution application and the standby application of the first container platform identifier.

8. A non-transitory computer-readable storage medium storing an update control program for causing a computer to function as the update management device according to claim 6.
